(19) United States
(12) Patent Application Publication
(10) Pub. No.: US 2010/0173041 A1
(43) Pub. Date: Jul. 8, 2010

(54) Camouflaged Bottles and Containers

(76) Inventor: Jared Michael Olivier, Thibodaux, LA (US)

Correspondence Address: Larry E Severin, Esq, 3581 Teaberry Circle, Seal Beach, CA, 90740, US

(21) Appl. No.: 12/649,589

(22) Filed: Dec. 30, 2009

Related U.S. Application Data
(60) Provisional application No. 61/141,362, filed on Dec. 30, 2008.

(51) Int. Cl. A23L 1/00; B05D 5/06

(52) U.S. Cl. 426/2; 427/280; 215/316; 215/386; 215/230; 383/61.3

(57) ABSTRACT

Camouflaged bottles and containers for carrying and concealing a material include: a carriable container adapted to retain the material; and a camouflage pattern imprinted on an exterior surface of the container. The camouflage pattern helps conceal the container and the material. The container may be a bottle with a camouflaged cap or be a bag with a zipper lock, and may have a label.

### RELATED APPLICATIONS

This application claims the benefit of the filing date of U.S. patent application Ser. No. 61/141,362, filed Dec. 30, 2008, which is incorporated herein by reference in its entirety.

### BACKGROUND OF THE INVENTION

The present invention generally relates to containers and more specifically to camouflaged bottles and containers.

It would be desirable to have a bottle or bag from which hunters could eat or drink, without spooking the animals.

### SUMMARY OF THE INVENTION

In one aspect of the present invention, a device for carrying and concealing a material includes: a carriable container adapted to retain the material; and a camouflage pattern imprinted on an exterior surface of the container; wherein the camouflage pattern helps conceal the container and the material.

In another aspect of the present invention, a method of camouflaging a container includes: providing a camouflage material; and imprinting the container with the camouflage material; thereby camouflaging the container.

In yet another aspect of the present invention, a method for concealing a food material includes: providing a container adapted to retain the food material; imprinting the container with a camouflage pattern matching a surrounding environment; and carrying the container in the surrounding environment; thereby concealing the container and the food material.

### BRIEF DESCRIPTION OF THE DRAWINGS

FIG. 1 is a front view of an embodiment of the present invention illustrating a beverage container with camouflage patterns;

FIG. 2 is a front view of an embodiment of the present invention illustrating differently-sized zipper bags with a camouflage pattern;

FIG. 3 depicts a deer being spooked by an uncamouflaged bottle; and

FIG. 4 depicts a deer in a calm and relaxed state while a hunter drinks out of an embodiment of a camouflaged bottle.

### DETAILED DESCRIPTION

The preferred embodiment and other embodiments, including the best mode of carrying out the invention, are hereby described in detail with reference to the drawings. Further embodiments, features and advantages will become apparent from the ensuing description or may be learned without undue experimentation. The figures are not drawn to scale, except where otherwise indicated. The following description of embodiments, even if phrased in terms of “the invention,” is not to be taken in a limiting sense, but describes the manner and process of making and using the invention. The coverage of this patent will be described in the claims. The order in which steps are listed in the claims does not indicate that the steps must be performed in that order.

An embodiment of the present invention generally provides camouflaged bottles and containers.

Embodiments of the invention provide camouflage drinking or storage containers that provide concealment for hunters or military personnel while in the field. Embodiments provide concealment of water or drinks such as Gatorade(R), or Powerade(R). By camouflaging the plastic of the bottle, wildlife game would not be spooked. An item is “camouflaged” when it is colored or marked so as to match or be generally indiscernible from the surrounding environment, such as a pattern resembling plants and leaves that match an environment having plants and leaves.

Whether duck hunting or deer hunting, an embodiment of a camouflaged container could allow great concealment when drinking water instead of having to buy canteens for water. Whether hunting or in the military, an embodiment of a camouflaged zipper seal bag could allow concealment when carrying and eating various food sources.

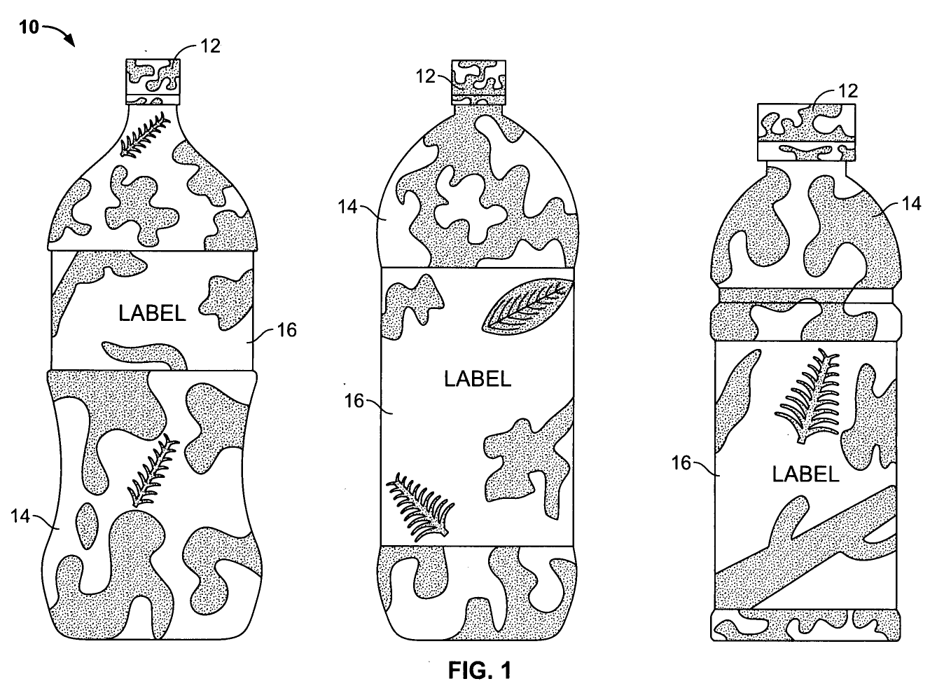

As depicted in FIG. 1, embodiments of a camouflaged container 10 includes a plastic drinking bottle 14 with a camouflage pattern, a plastic cap 12 to removably seal the bottle, and a label 16 for product description or other marketing information, also molded with the camouflage pattern.

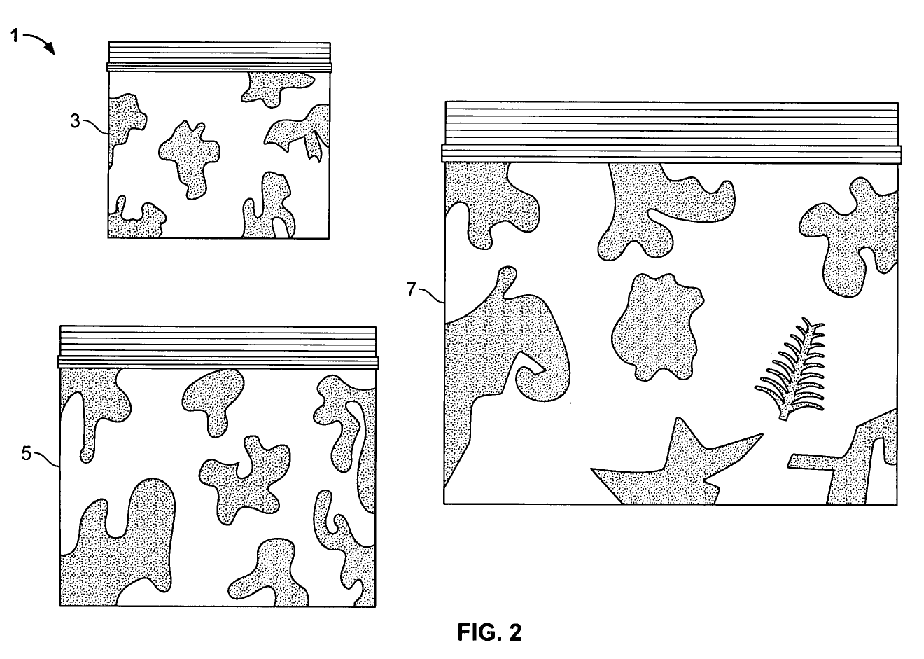

As depicted in FIG. 2, another embodiment 20 includes a sandwich-sized zipper bag 22, a quart-sized zipper bag 24, and a gallon-sized zipper bag 26, each molded with a camouflage pattern.

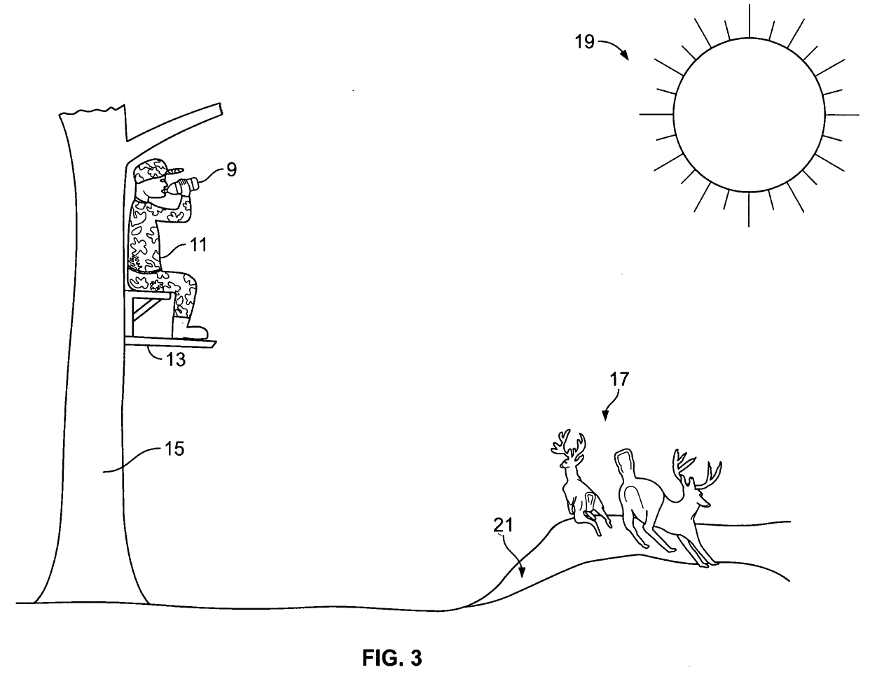

FIG. 3 is an illustration of a deer 38 being spook by an uncamouflaged bottle 30. A hunter 32 is wearing camouflaged clothing, but he is drinking out of the uncamouflaged bottle 30. He sits in a portable treestand 34 in a tree 36, under the sun 40 and over the terrain 42.

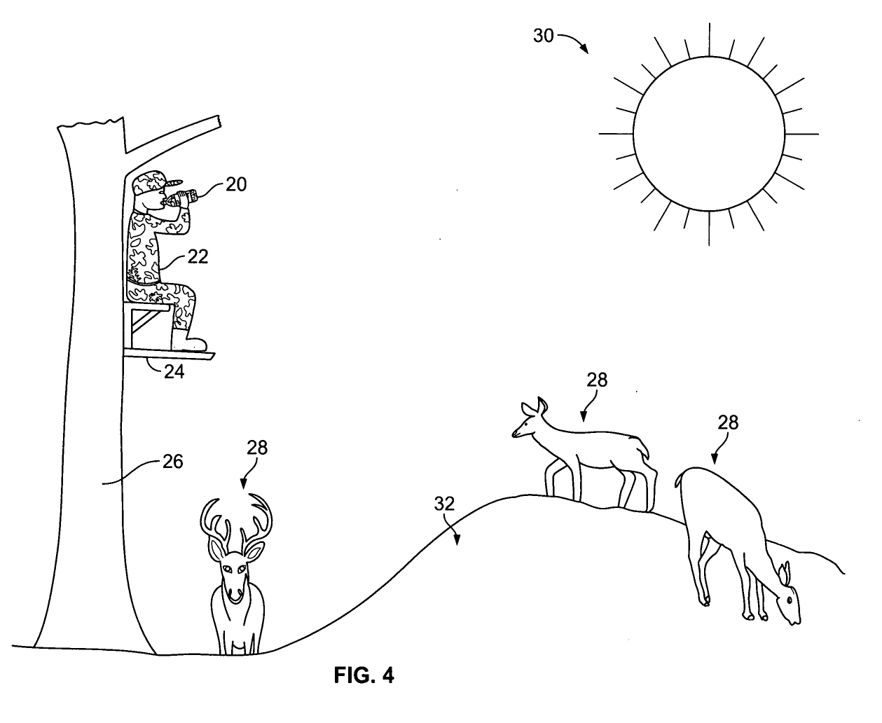

FIG. 4 is an illustration of a deer 58 in a calm and relaxed state, while the hunter 52 is drinking out of an embodiment of a camouflaged bottle 50. The hunter 52 is wearing camouflaged clothing, drinking out of the camouflaged embodiment of the present invention 50. He sits in a portable treestand 54 in a tree 56, under the sun 60 and over the terrain 62.

Embodiments of the invention include: camouflaged patterns (such as leaf, tree, branch, grass, jungle, or desert patterns); drinking containers (such as plastic water bottles, plastic Gatorade(R) or Powerade(R) bottles, plastic soft drink bottles, aluminum cans, and juice boxes); and storage containers (such as storage zipper bags or Tupperware(R)).

An embodiment of the present invention is a camouflaged container, which is made up of the following elements: polycarbonate or polyethylene plastic; aluminum; and camouflage patterns. The camouflage patterns are molded or imprinted onto the plastic or aluminum. This may be done by dipping plastic or aluminum containers into vats containing camouflaged liquid. Once dried, this will produce various camouflaged patterns on the containers.

To use an embodiment, camouflage a plastic water bottle to provide concealment for hunters while drinking.

In other embodiments, plastic on a bottle may be camouflaged for any drink that a hunter might want to purchase. Also, military forces such as the Armed Forces of the United States may use these camouflaged water bottles for concealment while in combat.

I claim:

1. A device for carrying and concealing a material, comprising:
a carriable container adapted to retain the material; and
a camouflage pattern imprinted on an exterior surface of the container;
wherein the camouflage pattern helps conceal the container and the material.

2. The device of claim 1, wherein the material is a food and the container is adapted to releasably carry the food for eating.

3. The device of claim 1, wherein the material is a liquid and the container is adapted to releasably carry the liquid for drinking.

4. The device of claim 1, wherein the container is a plastic drink bottle, aluminum can, or juice box.

5. The device of claim 1, wherein the container is a bottle, further comprising:
a cap adapted to seal and unseal the bottle;
wherein the camouflage pattern is imprinted on an exterior surface of the cap.

6. The device of claim 1, further comprising:
a label having a camouflage pattern, imprinted on the exterior surface of the container.

7. The device of claim 1, wherein the container is a bag, further comprising:
a seal adapted to releasably retain the bag closed so as to releasably enclose the material.

8. The device of claim 1, further comprising:
a lid adapted to releasably seal the container; and
a camouflage pattern imprinted on the lid.

9. The device of claim 1, wherein the container is a bag adapted to retain food, further comprising:
a zipper adapted to open and close the bag so as to retain the food for eating.

10. The device of claim 1, wherein the camouflage pattern is selected from the group consisting of: leaf, tree, branch, grass, jungle, and desert pattern.

11. A method of camouflaging a container, comprising:
providing a camouflage material; and
imprinting the container with the camouflage material; thereby camouflaging the container.

12. The method of claim 11, wherein the camouflage material is a camouflage fluid, and the container is coated with the camouflage fluid to camouflage the container.

13. The method of claim 11, wherein the container is a bottle adapted to retain a liquid for drinking.

14. The method of claim 11, further comprising:
imprinting a cap of the container with the camouflage material;
thereby camouflaging the container and the cap.

15. A method for concealing a food material, comprising:
providing a container adapted to retain the food material;
imprinting the container with a camouflage pattern matching a surrounding environment; and
carrying the container in the surrounding environment;
thereby concealing the container and the food material.

16. The method of claim 15, wherein the surrounding environment is selected from the group consisting of: leaf, tree, branch, grass, jungle, and desert.

17. The method of claim 15, wherein the food material is a liquid for drinking, and the container is a plastic drink bottle, aluminum can, or juice box.

18. The method of claim 15, further comprising:
sealing the container;
carrying the container;
unsealing the container; and
consuming the food material.
